(19) United States
(12) Patent Application Publication
(10) Pub. No.: US 2024/0311675 A1
(43) Pub. Date: Sep. 19, 2024

(54) QUANTUM INFORMATION SYSTEM

(71) Applicants: Michael STERN, Givat Shmuel (IL); Eytan GROSFELD, Be'er Sheva (IL); Eran GINOSSAR, Hampshire (GB); Paul BROOKES, London (GB); Marzena SZYMANSKA, London (GB)

(72) Inventors: Michael STERN, Givat Shmuel (IL); Eytan GROSFELD, Be'er Sheva (IL); Eran GINOSSAR, Hampshire (GB); Paul BROOKES, London (GB); Marzena SZYMANSKA, London (GB)

(21) Appl. No.: 18/575,544

(22) PCT Filed: Jun. 30, 2022
(86) PCT No.: PCT/GB2022/051681

§ 371 Date: Dec. 29, 2023

(30) Foreign Application Priority Data
Jul. 1, 2021 (GB) 2109522.9

(51) Int. Cl. G06N 10/40

(52) U.S. Cl. CPC G06N 10/40

(57) ABSTRACT

A system for representing quantum information, such as for storing and processing quantum information, is formed from a chain of quantum objects. The number of quantum objects is at least six, and each quantum object is characterized by a local quantum degree of freedom. A plurality of coupling elements couple the local quantum degrees of freedom of the quantum objects: and the system has at least two quantum mechanical states of different energy. useable for representing information. The strengths of the couplings provided by the coupling elements are such that: (i) the two quantum mechanical states are invariant under the action of a translation operator. the action of the translation operator being to displace each quantum object to a nearest neighbor quantum object: and (ii) the two quantum mechanical states are eigenstates of an inversion operator with opposite eigenvalues. the action of the inversion operator being to invert the quantum objects about a point of symmetry. In one example, the chain is in the form of a loop, and each quantum object is coupled to its nearest neighbor quantum objects, and to a diametrically opposite quantum object, with different coupling coefficients. The quantum objects can be, for example, superconducting Cooper-pair boxes, and the coupling elements can be Josephson junctions.

### FIELD OF THE INVENTION

The present invention relates to a system for representing quantum information, such as for storing and processing quantum information. Such a system can be used, for example, as a building block of a quantum computer.

### BACKGROUND

In a quantum computer, information is represented by the quantum mechanical states of a system. Under the laws of quantum mechanics, the quantum mechanical state of a many level system can be in any superposition of the eigenstates associated with said levels. In a two-level system (or qubit), the system has two possible eigenstates and therefore its quantum state can be any superposition of the so-called “basis states” 0 and 1.

The field of quantum computation has been the subject of much research. However, constructing such a computer is an extremely difficult task. One important requirement for the successful operation of a quantum computer is that the system maintains the desired superposition state for a time longer than the time required to carry out a calculation. The effect of the outside environment with which the system necessarily interacts is to introduce noise that tends to “decohere” the system, such that the quantum information is potentially lost after a characteristic decoherence time.

However, there is the converse problem that the better protected a qubit is from its environment, the harder it is to initialize and control the qubit, and to get the final result of the operation.

The present invention aims to alleviate, at least partially, some or any of the above problems.

### SUMMARY

According to one aspect of the invention there is provided a system for representing quantum information, the system comprising:
a chain comprising a plurality of quantum objects, the number of quantum objects being at least six, each quantum object being characterized by a local quantum degree of freedom; and
a plurality of coupling elements to couple the local quantum degrees of freedom of the quantum objects,
wherein the system has at least two quantum mechanical states of different energy, useable for representing information, and
the strengths of the couplings provided by the coupling elements are such that:
(i) said two quantum mechanical states are substantially invariant under the action of a translation operator, the action of the translation operator being to displace each quantum object to a nearest neighbor quantum object: and
(ii) said two quantum mechanical states are substantially eigenstates of an inversion operator with opposite eigenvalues, the action of the inversion operator being to invert the quantum objects about a point of symmetry.

Further optional aspects of the invention are defined in the dependent claims.

### BRIEF DESCRIPTION OF THE DRAWINGS

Embodiments of the invention will now be described, by way of non-limiting example. The system or apparatus of the invention may further comprise, in any combination, any features of the embodiments of the invention which will now be described by way of example only with reference to the accompanying drawings.

FIG. 1 is a schematic illustration of a topological arrangement of a system comprising six quantum objects in a loop according to an embodiment of the invention;

FIG. 2 is a schematic illustration of a topological arrangement of a system comprising eight quantum objects in a loop according to another embodiment of the invention:

FIG. 3 is an illustration of a system according to an embodiment of the invention employing superconductive circuit elements coupled by Josephson junctions:

FIG. 4 is a plot of the transition frequency 001/2x between the ground and first excited states of the system of FIG. 3:

FIG. 5 is a circuit diagram of an apparatus incorporating the system of FIG. 3: and

FIG. 6 is an illustration of a control sequence for the apparatus of FIG. 5 to initialize a qubit.

In the drawings, like parts are indicated with like reference numerals, and, for conciseness, description thereof will not be repeated.

### DETAILED DESCRIPTION

An embodiment of the invention comprises a chain of quantum objects. The chain can be open: or the chain can be closed on itself such that the quantum objects are connected in a loop. The loop can also be referred to as a ring, but no specific circular shape or geometry is required. The following specific embodiments will be described in the form of a loop, but that is merely one example of a chain.

Each quantum object has a specific local quantum mechanical degree of freedom of interest (a quantum mechanical degree of freedom being an independent physical parameter used in describing the quantum mechanical state of the object, and also abbreviated to ‘quantum degree of freedom’), for example spin value in a given direction, charge, magnetic flux, energy, polarization, phase, current, or a combination of such properties. The quantum mechanical local degree of freedom can have multiple discrete values or states. If two of these values or states are used, then the quantum object can represent a qubit.

FIG. 1 illustrates an embodiment of a system having a loop 10 comprising six quantum objects 11-16. Each quantum object is coupled to the quantum objects immediately adjacent to it in the loop 10 by a respective non-linear coupling element 18. Two quantum objects can interact with each other via a coupling element 18, for example by exchanging excitations between the quantum objects, to affect the quantum mechanical state of each quantum object. The ‘strength’ or ‘rate’ of the interaction is determined by a coupling coefficient of the relevant coupling element, and is non-linear with respect to the quantum degree of freedom in question (such as magnetic flux, spin etc). So, for example, quantum object 12 is directly coupled with its nearest neighbor quantum objects 11 and 13, and each non-linear coupling element 18 has a first coupling coefficient fixing the strength of the coupling interaction.

Each quantum object also has direct long-range coupling with at least one quantum object other than its nearest neighbors, which can in general be called the nth nearest neighbor. Referring to FIG. 1, for quantum object 11, a nearest neighbor (i.e. 1^{st} nearest neighbor) is quantum object 12, a 2^{nd} nearest neighbor is quantum object 13, and a 3^{rd} nearest neighbor is quantum object 14. Couplings can also be referred to as being of ‘range l’ for nearest neighbors, ‘range 2’ for 2^{nd} nearest neighbors, ‘range 3’ for 3^{rd} nearest neighbors, and so on. As shown in FIG. 1, quantum object 11 is coupled to its 3^{rd} nearest neighbor quantum object 14 via non-linear coupling element 20. Similarly, each quantum object 11-16 in the ring 10 is coupled to its 3^{rd} nearest neighbor by respective non-linear coupling elements 20. In this specific embodiment of the six quantum object loop, the 3^{rd} nearest neighbor is the diametrically opposite quantum object. These non-linear coupling elements 20 for the long-range interactions have a second coupling coefficient that is different from the first coupling coefficient of the coupling elements 18 for the nearest neighbor couplings. In particular the first coupling coefficient and the second coupling coefficient are of opposite sign, and can be of different value. However, in a preferred embodiment, the first coupling coefficient and the second coupling coefficient are of similar magnitude.

The six quantum objects in the loop 10 collectively form a system that has a spectrum of energy levels governed by the states of each quantum object and their interactions. Two of these energy levels or collective states, such as the ground state and a first excited state, can be used to represent a qubit of quantum information. The presence of the long-range couplings, and the symmetry of the loop, means that the coherence of a qubit formed by two of these states is improved compared with a system without the long-range interaction. For example, the influence of noise coupled to any one quantum object tends to be suppressed because of the symmetry.

The couplings described above as non-linear can also include a linear component. In the general system, there is also an all-to-all coupling linking all of the quantum objects together, and this all-to-all coupling is not necessarily non-linear i.e. can be linear.

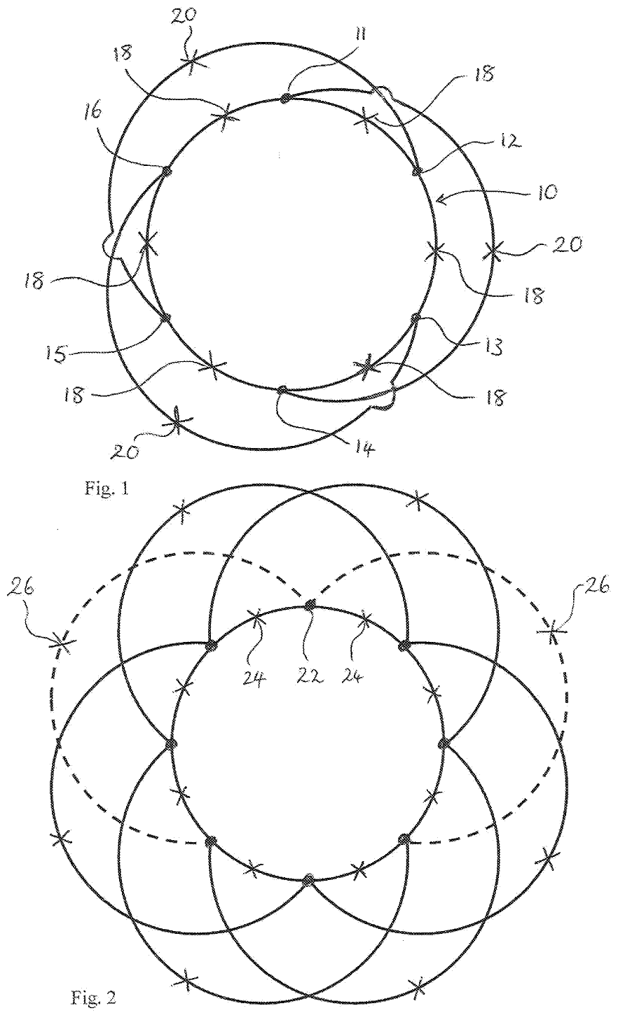

The system of FIG. 1 is merely one example, and it can be extended to different numbers of quantum objects in the loop. For symmetry reasons, the number of quantum objects should be an even number, and to permit range 3 or higher coupling in the loop, the minimum number of quantum objects is six. FIG. 2 illustrates a loop of eight quantum objects 22. Each quantum object 22 is coupled to its nearest neighbor quantum objects in the loop (i.e. 1^{st} nearest neighbors) by respective non-linear coupling element 24 having a first coupling coefficient. And each quantum object 22 is coupled to its 3^{rd} nearest neighbor quantum objects in the loop by respective non-linear coupling elements 26 having a second coupling coefficient. For clarity, in FIG. 2, only the quantum object 22 at the top of the loop in the illustration and its coupling elements 24, 26 have been labelled, and the long-range connection paths from this quantum object 22 have been shown as dashed lines. However, the complete topology is shown for all eight quantum objects. All-to-all couplings have also not been illustrated in FIG. 2.

The long-range couplings are not limited only to the 3^{rd} nearest neighbors: other embodiments of the invention can use higher range, and can use multiple different ranges of couplings.

In particularly preferred embodiments of the invention, the two quantum mechanical states of the loop for representing a qubit are the ground state and the first excited state, and the first and second coupling coefficients are selected such that: (i) the ground state and first excited state are substantially invariant under the action of a translation operator, the action of the translation operator being to displace each quantum object round the loop to the nearest neighbor quantum object: and (ii) the ground state and first excited state are substantially eigenstates of an inversion operator with opposite eigenvalues, the action of the inversion operator being to invert the quantum objects around a point of symmetry of the system. Embodiments with these specific symmetries, or substantially close thereto, but not necessarily 100% perfectly possessing these symmetries, exhibit superior coherence time of the qubit because, as can be shown, the relaxation and dephasing of the qubit are both supressed.

A Hamiltonian can be constructed for a system comprising a loop of spin-1/2 quantum mechanical spins, with nearest-neighbor couplings, long-range couplings, and all-to-all couplings. The Schroedinger equation for the system with particular values for the coupling strengths is solved to find the eigenstates and eigenvalues of the Hamiltonian. It can then be checked whether the ground state and first excited state satisfy the above symmetries. This is done by applying the relevant operator on the vector of the Hilbert space which corresponds to the ground state or first excited state of the system. Thus sets of values of coupling strengths (coefficients) can be obtained that provide a system that satisfies the desired symmetries. When the symmetries are obeyed, it can be shown that the relaxation rate and dephasing rate of the qubit are suppressed.

In the specific implementations described below, the quantum object is a superconducting Cooper-pair box (also known as a charge qubit), but other suitable quantum objects include impurity spins, quantum dots, and carbon nanotubes. Suitable coupling elements depend on the nature of the quantum objects, and the relevant quantum mechanical degree of freedom (property) being coupled, but in the specific embodiments described herein, each coupling element is a Josephson junction (in the form of a superconducting tunnel junction). A Hamiltonian can be engineered for these embodiments that is analogous to the simple spin-1/2 system mentioned above, but with Cooper pairs now taking the role of the excitations which can now tunnel between sites via Josephson junctions. The circuit of the following implementations respects the translation and inversion symmetries identified above. To determine whether a system of quantum objects and coupling elements satisfies requirements to embody the invention, one technique is to solve the Schroedinger equation for the system to find the eigenstates and eigenvalues of the Hamiltonian, then check whether the ground state and first excited state satisfy the above symmetries. This is done by applying the relevant operator on the vector of the Hilbert space which corresponds to the ground state or first excited state of the system.

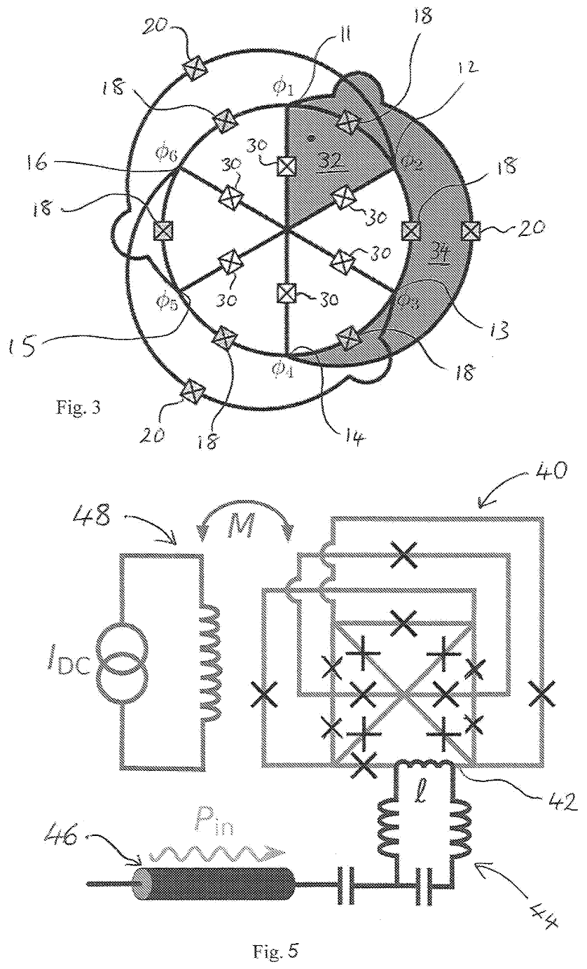

FIGS. 3 and 5 illustrate an example of a specific system or circuit embodying the invention. The system shown schematically in FIG. 3 is similar to FIG. 1, and in this specific embodiment comprises a loop of superconductive material 10 intersected by six identical azimuthal Josephson junctions 18 which have Josephson energy E_{Ja}. In this design, each quantum object 11-16 is connected to a common point (or ground) by a respective radial Josephson junction 30. Thus each quantum object 11-16 comprises an island of superconductor, and is in the form of a superconducting Cooper-pair box. Each radial Josephson junction 30 has a Josephson energy E_{Jr} and a charging energy E_{Cr}. Each quantum object comprises a superconducting Cooper-pair box with a ratio 0.05<E_{Jr}/E_{Cr}<1.0. The state of each quantum object (the phase of the potential of the box) is coupled by flip-flop interactions to the nearest neighbor quantum objects via the azimuthal Josephson junctions 18, and to the diametrically opposite quantum object via Josephson junctions 20 of Josephson energy E_{Jl}. The charging energy of the azimuthal junctions 18 is E_{Ca}, and is selected such that E_{Ca}/E_{Cr}<<1.

We now outline the process of quantizing the circuit to obtain its Hamiltonian. The circuit is treated as a graph consisting of a grounded node in the centre connected to 6 outer nodes via radial Josephson junctions. The voltage of node n at time t is written as vₙ(t), from which we define the node fluxes by ϕₙ(t)=∫_{-∞}^{t}vₙ(t′)dt′. The Lagrangian L is then divided into a kinetic part T which consists of the capacitive charging energies, and a potential part V which is the sum of the inductive energies of the Josephson junctions: L=T−V. If we denote the capacitances of the radial, azimuthal (nearest-neighbor) and outer (next-next-nearest-neighbor) junctions by Cᵣ, Cₐ and Cₗ respectively then we can write the kinetic term as

$$\begin{matrix}T = \frac{1}{2} {{\sum }^{6}}_{m = 1} [ {{C}_{a} ( {\dot{ϕ}}_{m + 1} - {\dot{ϕ}}_{m} )}^{2} + {C}_{r} {\dot{ϕ}}_{m}^{2} ] + \frac{1}{2} {{\sum }^{3}}_{m = 1} {{C}_{l} ( {\dot{ϕ}}_{2 m} - {\dot{ϕ}}_{2 m + 3} )}^{2} \\ = \frac{1}{2} {{\sum }^{6}}_{m , n = 1} {C}_{mn} {\dot{ϕ}}_{m} {\dot{ϕ}}_{n}\end{matrix}$$

where in the second line we have introduced the capacitance matrix:

$$C = ( \begin{matrix}{C}_{r} + 2 {C}_{a} + {C}_{l} & - {C}_{a} & 0 & - {C}_{l} & 0 & - {C}_{a} \\ - {C}_{a} & {C}_{r} + 2 {C}_{a} + {C}_{l} & - {C}_{a} & 0 & - {C}_{l} & 0 \\ 0 & - {C}_{a} & {C}_{r} + 2 {C}_{a} + {C}_{l} & - {C}_{a} & 0 & - {C}_{l} \\ - {C}_{l} & 0 & - {C}_{a} & {C}_{r} + 2 {C}_{a} + {C}_{l} & - {C}_{a} & 0 \\ 0 & - {C}_{l} & 0 & - {C}_{a} & {C}_{r} + 2 {C}_{a} + {C}_{l} & - {C}_{a} \\ - {C}_{a} & 0 & - {C}_{l} & 0 & - {C}_{a} & {C}_{r} + 2 {C}_{a} + {C}_{l}\end{matrix} ) .$$

In order to write down the potential term we must be careful to take account of any fluxes which may be threading through the loops of the circuit. We first define a spanning tree which reaches all nodes of the circuit without forming any loops. In the present case this spanning tree consists of all the radial Josephson junctions. Each Josephson junction in the circuit makes a contribution to the inductive energy of the form −Eⱼcos(ϕ/φ₀o) where ϕ is the difference in node fluxes across that junction and do is the reduced flux quantum. For junctions lying within the spanning tree, i.e. the radial junctions, this phase difference is simply given by the node fluxes ϕₙ(t). However if the junction lies outside the spanning tree then the flux difference must account for the external flux threaded through the loop it forms. According to Maxwell's equations the change in potential energy when traversing a loop is proportional to the rate of change of magnetic flux through that loop:

$$∮ E \cdot dx = - {\partial }_{t} {Φ}_{ext} .$$

If we integrate this relation over time then we find that the sum of flux differences across circuit elements within a loop will be equal to the external flux threading the loop. This allows us to write the flux differences across the mth azimuthal Δϕ_{a,m} and outer Δϕ_{l,m} junctions as

$$\begin{matrix}Δ {ϕ}_{a , m} = {ϕ}_{m + 1} - {ϕ}_{m} - {Φ}_{a , m} \\ Δ {ϕ}_{l , m} = {ϕ}_{2 m + 3} - {ϕ}_{2 m} - {Φ}_{l , m}\end{matrix}$$

where Pam and dim are the external fluxes threading through the loops formed by these junctions. Finally, these flux differences can be used to write the potential part of the Lagrangian as

$$V = - {E}_{Jr} {\sum }_{m = 1}^{6} cos ( \frac{{ϕ}_{m}}{{ϕ}_{0}} ) - {E}_{Ja} {\sum }_{m = 1}^{6} cos ( \frac{{ϕ}_{m + 1} - {ϕ}_{m} - {Φ}_{am}}{{φ}_{0}} ) \\ - {E}_{Jl} {\sum }_{m = 1}^{3} cos ( \frac{{ϕ}_{2 m + 3} - {ϕ}_{2 m} - {Φ}_{lm}}{{φ}_{0}} ) .$$

To convert this Lagrangian to the form of a Hamiltonian we must first obtain the node charges. These are given by

$${q}_{m} = \frac{\partial L}{\partial {\dot{ϕ}}_{m}} = {\sum }_{n = 1}^{6} {C}_{mn} {\dot{ϕ}}_{n}$$

After performing a Legendre transformation, the Hamiltonian is given by

$$H = {\sum }_{m = 1}^{6} {\dot{ϕ}}_{m} {q}_{m} - L = T + V$$

where we now express the kinetic term as

$$T = \frac{1}{2} {\sum }_{m , n = 1}^{6} {C}_{mn}^{- 1} {q}_{m} {q}_{n}$$

This Hamiltonian can be quantized by replacing qₙ→2e(\hat{N}ₙ-N_{g,n}) and ϕₙ/φ₀→\hat{θ}ₙ where N_{g,n} is the gate charge on site n and the commutation relation [\hat{θ}ₙ, \hat{N}ₙ]=i holds. This gives the complete Hamiltonian in the form

$$H = 2 {e}^{2} {\sum }_{m , n = 1}^{6} {C}_{mn}^{- 1} ( {\hat{N}}_{m} - {N}_{g , m} ) ( {\hat{N}}_{n} - {N}_{g , n} ) - {E}_{Jr} {\sum }_{m = 1}^{6} cos ( {\hat{θ}}_{m} ) \\ - {E}_{Ja} {\sum }_{m = 1}^{6} cos ( {\hat{θ}}_{m + 1} - {\hat{θ}}_{m} - \frac{{Φ}_{am}}{{φ}_{0}} ) \\ - {E}_{Jl} {\sum }_{m = 1}^{3} cos ( {\hat{θ}}_{2 m + 3} - {\hat{θ}}_{2 m} - \frac{{Φ}_{lm}}{{φ}_{0}} ) .$$

If we denote the fluxes through the six inner and three outer loops of the circuit by Φ_{I,m} and Φ_{O,m} then we can rewrite the external fluxes as:

$${Φ}_{am} = {Φ}_{I , m} , {Φ}_{lm} = {Φ}_{I , m} + {Φ}_{I , m + 1} + {Φ}_{I , m + 2} + {Φ}_{O , m} .$$

We can now demonstrate the relationship between this Hamiltonian and that of a simple model system comprising a loop of six spins. We start with the potential term which recreates the flip-flop couplings of the spin-1/2 model. We can see this by rewriting the potential in terms of the tunneling operators

$${{{{{\sum }_{m}^{+} = {\sum }_{n} \vert n + 1 〉}_{m} 〈 n \vert}_{m} , {\sum }_{m}^{-} = {\sum }_{n} \vert n 〉}_{m} 〈 n + 1 \vert}_{m}$$

which cause Cooper pairs to tunnel back and forth across the radial junctions, and are written in terms of the Cooper pair number states Nₘ|n [symbol] ₘ=n|n [symbol] ₘ. These operators allow us to represent the cosine and sine functions as

$$cos ( {\hat{θ}}_{m} ) = \frac{1}{2} ( {\sum }_{m}^{-} + {\sum }_{m}^{+} ) , sin ( {\hat{θ}}_{m} ) = \frac{i}{2} ( {\sum }_{m}^{-} - {\sum }_{m}^{+} ) .$$

Using compound angle formulae the nearest neighbor coupling is then rewritten as

$$cos ( {\hat{θ}}_{m + 1} - {\hat{θ}}_{m} - \frac{{Φ}_{am}}{{φ}_{0}} ) = \frac{1}{2} ( {\sum }_{m}^{+} {\sum }_{m + 1}^{-} {e}^{i {Φ}_{am} / {φ}_{0}} + {\sum }_{m}^{-} {\sum }_{m + 1}^{+} {e}^{- i {Φ}_{am} / {φ}_{0}} ) .$$

Similarly the diametric coupling is rewritten as

$$cos ( {\hat{θ}}_{m + 3} - {\hat{θ}}_{m} - \frac{{Φ}_{lm}}{{φ}_{0}} ) = \frac{1}{2} ( {\sum }_{m}^{+} {\sum }_{m + 3}^{-} {e}^{i {Φ}_{lm} / {φ}_{0}} + {\sum }_{m}^{-} {\sum }_{m + 3}^{+} {e}^{- i {Φ}_{lm} / {φ}_{0}} ) .$$

In order to arrange the current signs for these couplings we simply choose Φₐₘ/φ₀=π and Φₗₘ/φ₀=4π.

Next we look at the charge coupling. In the limit Cᵣ/Cₐ→0 the inverse of the capacitance matrix gives an all to all charge coupling according to

$${C}_{mn}^{- 1} \to \frac{1}{6 {C}_{r}} , T \to \frac{2}{3} {E}_{Cr} {\sum }_{m , n = 1}^{6} ( {\hat{N}}_{m} - {N}_{g , m} ) ( {\hat{N}}_{n} - {N}_{g , n} ) .$$

If the gate charges are tuned to a half integer then we can make the identification

$$\hat{N} - {N}_{g} ∼ \frac{1}{2} {σ}^{z}$$

and this coupling will be of the same form as the all-to-all σₘ^{z}σₙ^{z} coupling.

In this manner we can use the circuit (FIGS. 3 and 5) to engineer a Hamiltonian which is analogous to that of a simple spin-1/2 model with Cooper pairs now taking the role of the excitations which can now tunnel between sites via Josephson junctions. The circuit respects the key translation and inversion symmetries identified earlier; however whereas a simple spin model consists of two-level sites, each site in the present circuit has many levels.

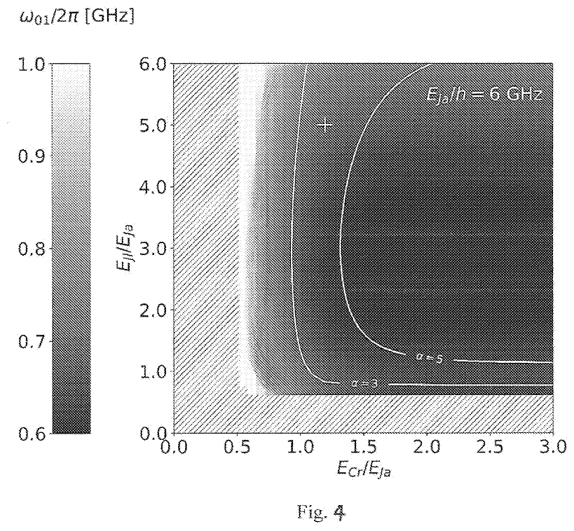

The relative sign of the flip-flop interactions is controlled by the choice of the flux threading through the superconductive circuit. At the optimal point, the flux threading through each internal sector (e.g. region 32) is tuned to half a flux quantum Φ₀/2, while the flux threading the outer portions (e.g. region 34) is 3Φ₀/2. This is achieved in this embodiment by applying a homogeneous external magnetic field and fabricating the circuit with an appropriate geometry. For ease of fabrication, in this embodiment, all three Josephson junction types (azimuthal 18: radial 30, and long-range coupling 30) have the same plasma frequency: \sqrt{8E_{J}E_{C}}/h=10 GHz. FIG. 4 shows a plot of the transition frequency ω₀₁/2π between the ground and first excited states of the system of FIG. 3 as a function of E_{Cr}/E_{Ja} and E_{Jl}/E_{Ja} assuming Eⱼₐ/h=6 GHz. The strengths of the nearest neighbor flip-flop, range 3 flip-flop and all-to-all couplings are proportional to E^{Ja}, E_{Jl} and E_{cr} respectively. The L-shaped hatched region to the left and bottom of the plot of FIG. 4, corresponds to parameters where the ground and first excited states do not exhibit the desired symmetries for protection of the qubit against decoherence. The white lines are contours of constant anharmonicity (α=ω₁₂/ω₀₁). A set of three junction parameters is selected such that the ground state and first excited state (of the collective system comprising the circuit of FIG. 3, which will be useable to represent a qubit) satisfy the desired symmetries. A particular set of parameters for an embodiment as discussed further below is (E_{Jr}/h=1.7 GHZ, E_{Ja}/h=6 GHz and E_{Jl}/h=30 GHz), indicated by the white cross in FIG. 4. With these parameters, the transition frequency f of the qubit circuit system is 704 MHZ (f=ω₀₁/2π, where ω₀₁ is the transition frequency between the ground and first excited states of the circuit). The anharmonicity of transitions to the next excited state is ω₁₂/ω₀₁=4, where ω₁₂ is the transition frequency between the first and second excited states of the circuit. This large anharmonicity means that the qubit states can be addressed without the participation of higher levels: thus the problem of ensuring the states used for representing the qubit are well separated from the rest of the spectrum is overcome.

The physical meaning of the qubit states can be understood in terms of a superposition of persistent currents flowing round the superconductive circuit. One can decompose the current into: (i) a clockwise current flowing in each azimuthal junction 18 of Iₚ=I_{ca} sin(π/3) where I_{ca} is the critical current of these junction; and (ii) a similar anti-clockwise current of Iₚ=I_{ca} sin(π/3): while the currents in the outer (range 3) junctions 20 are all zero. The ground state wavefunction of the qubit consists of a symmetric superposition of these clockwise and anti-clockwise current states, and the first excited wavefunction consists of an anti-symmetric superposition of these clockwise and anti-clockwise current states. In the present embodiment, the magnitude of the persistent current Iₚ is of the order of 10 nA. At the optimal operating point of the present embodiment, the rate of relaxation due to quasi-particle tunnelling is about 0.2 kHz, corresponding to a relaxation time of about 5 ms. Dephasing times are typically in the millisecond range, such as between 1 to 10 ms. This performance represents an improvement over the state of the art by a factor of about 10.

As explained above, for the quantum mechanical states used for representing information, the specified symmetries do not have to be absolutely perfectly satisfied. Some degree of disorder can be present without losing the advantageous behaviour of the system. For example, in the case of the embodiment of FIG. 3, it can be shown that no significant degradation in the qualities of the qubit is created by a 2% variation in the sizes and oxidation parameters of the Josephson junctions, nor by a 0.2% variation in the sizes of the loops (and consequent variation in fluxes). Similarly, a 0.1% variation in the gate charges for the islands is acceptable and maintains the dephasing time in the millisecond range. All of these disorder variations are within the ambit of the invention. Similarly, for an open chain of quantum objects, the symmetry of the states will be broken at the ends of the chain, but an improved performance can still be obtained over conventional systems.

FIG. 5 is a circuit diagram of one embodiment of an apparatus for controlling, initializing and reading the qubit state of the system of FIG. 3 by coupling the qubit system to a microwave resonator. In FIG. 5, the superconductive circuit of FIG. 3 is in the upper-right portion 40. The Josephson junctions are indicated by their electronic circuit symbol of a cross. The primary loop in this diagram is drawn as the small square with six Josephson junctions around its perimeter (the azimuthal junctions), and six radial Josephson junctions meeting at a point. The three diametric connections are shown as longer outer superconductive wiring paths, each having a Josephson junction. The circuit is fabricated using standard techniques from microelectronics.

One of the sectors 42 of the circuit loop is galvanically connected to a resonator 44, such that they share a constricted wire of inductance l=40 pH. The resonator 44 comprises inductances and capacitances, as schematically shown, and has a resonance frequency ωᵣ. In this embodiment, the resonator 44 has a resonance frequency ωᵣ/2π=3 GHZ, and a quality factor Q=ωᵣ/κ=10 000. The strength of the resulting Jaynes-Cummings coupling between the resonator 44 and the qubit system is arranged to be g/2π˜11 MHz. The resonator 44 is coupled to a waveguide 46 for conveying microwave pulses between an oscillator (not shown) and the resonator 44.

In addition, the apparatus has an electromagnet, such as a DC flux line 46, located in the vicinity of the qubit system, to apply magnetic flux to the circuit 40 to bias the operating point of the qubit system, in order to adiabatically control the transition frequency, as described further below. The qubit can be biased by the flux line 46, which can be used to detune the flux threading the qubit away from the optimal point, for the purposes of initialization and readout.

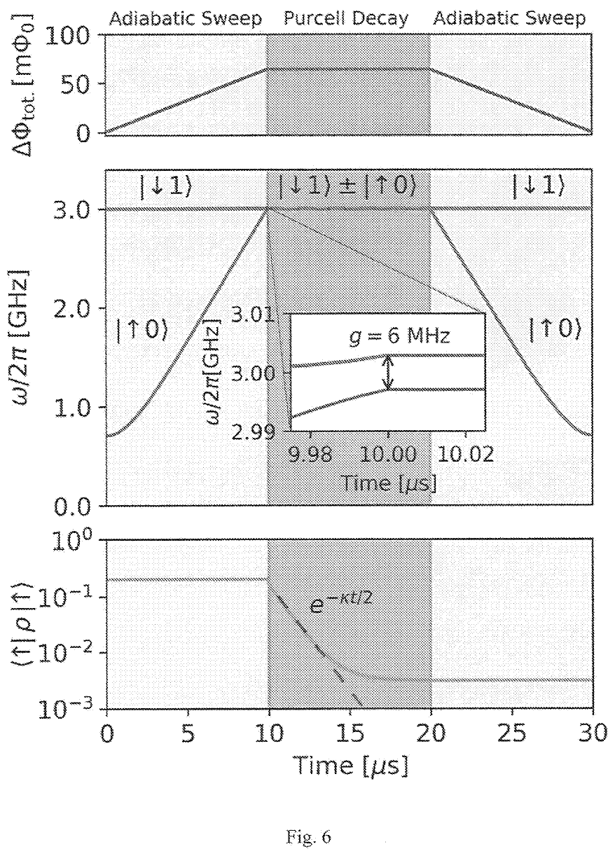

The apparatus of FIG. 5 enables Purcell initialization of the qubit to be performed as now described with reference to the control sequence shown in FIG. 6. Initialization is particularly challenging given the small transition frequency of the qubit. For example, at the base temperature (e.g. 25 mK) of a dilution refrigerator (in which the qubit system can be located) the thermal equilibrium state of the qubit will be highly mixed, i.e. the first excited state will be significantly occupied. In order to create a pure ground state, the flux line is used to adiabatically sweep the flux (upper plot of FIG. 6, left portion) to detune the qubit from its optimal point and to increase the ω₀₁ transition frequency, over a period of 10 μs, until it reaches the frequency of the resonator 44 (middle plot of FIG. 6, left portion). At this point the qubit system and the resonator 44 hybridize and the excited state of the qubit decays via the resonator at a rate κ/2˜1.5 MHz, as illustrated in FIG. 6, lower plot, middle section (Purcell decay). This new thermal state is much closer to a pure ground state because of the larger frequency of the resonator. After this operation has been completed, the flux can be adiabatically tuned back to the optimal operating point to obtain a ground state of purity 99.3% in this embodiment (FIG. 6, right portion).

At the optimal point, the resonator 44 can also be used to drive Rabi oscillations of the qubit system 40. For an input power Pᵢₙ of −80 dBm a Rabi frequency of Ω_{Rabi}/2π=10 MHz can be obtained, and a therefore a very high single qubit gate fidelity.

Finally, to perform readout the flux line can be used to adiabatically bring the qubit system 40 and resonator 44 into the strongly coupled dispersive regime defined by g²/|ωᵣ−ω₀₁|>κ and g/|ωᵣ−ωᵣ|<<1.

1. A system for representing quantum information, the system comprising:
a chain comprising a plurality of quantum objects, the number of quantum objects being at least six, each quantum object being characterized by a local quantum degree of freedom; and
a plurality of coupling elements to couple the local quantum degrees of freedom of the quantum objects,
wherein the system has at least two quantum mechanical states of different energy, useable for representing information, and
the strengths of the couplings provided by the coupling elements are such that:
(i) said two quantum mechanical states are substantially invariant under the action of a translation operator, the action of the translation operator being to displace each quantum object to a nearest neighbor quantum object: and
(ii) said two quantum mechanical states are substantially eigenstates of an inversion operator with opposite eigenvalues, the action of the inversion operator being to invert the quantum objects about a point of symmetry.

2. A system according to claim 1,
wherein each quantum object is coupled to each of its first nearest neighbor quantum objects by one of said coupling elements having a first coupling coefficient,
wherein each quantum object is coupled to at least one nth nearest neighbor quantum object, n>1, by one of said coupling elements having a second coupling coefficient,
wherein the first coupling coefficient and the second coupling coefficient are of opposite sign.

3. A system according to claim 2, wherein n=3, such that each quantum object is coupled to its 3^{rd} nearest neighbor quantum object by a coupling element having said second coupling coefficient.

4. A system according to any preceding claim, wherein said chain is one of: a periodic chain of said quantum objects: and a loop of said quantum objects.

5. A system according to any preceding claim, wherein said chain is in the form of a loop, the number of quantum objects in the loop is six, each quantum object is coupled to each of its first nearest neighbor quantum objects by a coupling element having a first coupling coefficient, and each quantum object is coupled to the quantum object diametrically opposite by a coupling element having a second coupling coefficient.

6. A system according to any preceding claim, wherein each coupling element provides a coupling strength having a coefficient of non-linear coupling.

7. A system according to any preceding claim, wherein said at least two quantum mechanical states of the system are the ground state and the first excited state.

8. A system according to any preceding claim, wherein each quantum object comprises a spin and the local quantum degree of freedom is the expectation value of the spin along a specific direction.

9. A system according to any preceding claim, wherein each quantum object comprises a superconducting Cooper-pair box and the local quantum degree of freedom is the phase of the potential of the box.

10. A system according to any preceding claim, wherein each coupling element is a Josephson junction.

11. An apparatus comprising a system according to any preceding claim and a microwave resonator coupled to the system for initialization and readout of the quantum information.

12. An apparatus according to claim 11, further comprising an electromagnet arranged to apply magnetic flux to the system.
